(19) United States
(12) Patent Application Publication
(10) Pub. No.: US 2015/0137567 A1
(43) Pub. Date: May 21, 2015

(54) LIFTING AND LOWERING CHAIR

(71) Applicant: Donna Marie Antoinette Smith, West Islip, NY (US)

(72) Inventor: Donna Marie Antoinette Smith, West Islip, NY (US)

(21) Appl. No.: 14/548,951

(22) Filed: Nov. 20, 2014

Related U.S. Application Data
(60) Provisional application No. 61/906,718, filed on Nov. 20, 2013.

(51) Int. Cl. A61G 5/14; A61G 5/10

(52) U.S. Cl. CPC A61G 5/14; A61G 5/1056
USPC 297/183.1; 297/344.12

(57) ABSTRACT

A lifting and lowering chair is provided. The lifting and lowering chair includes a base having an upper side and a lower side. The lower side is formed to rest on a surface, supporting the lifting and lowering chair in an upright position. The present invention further includes a lifting actuator attached to the base and a chair attached to the lifting actuator. The lifting actuator is operable to lift the chair to an extended position and retract the chair to a retracted position. The extended position includes a greater distance from the base to the chair as compared to the retracted position. Therefore, a disabled user may lower themselves and raise themselves from the floor.

### CROSS-REFERENCE TO RELATED APPLICATION

This application claims the benefit of priority of U.S. provisional application Ser. No. 61/906,718, filed Nov. 20, 2013, the contents of which are herein incorporated by reference.

### BACKGROUND OF THE INVENTION

The present invention relates to chairs and, more particularly, to a lifting and lowering chair.

During rehabilitation or yoga, some of the exercises are performed at floor level. It may be very difficult for the handicapped, injured or elderly to get to the floor level and back up. Other similar devices assist in pushing off the individual from the chair to a bed as an example. Others simply assist in relocating individuals from place to place in a sling type chair.

As can be seen, there is a need for a lifting chair for raising and lowering individuals from the floor.

### SUMMARY OF THE INVENTION

In one aspect of the present invention, a lifting chair comprises: a base having an upper side and a lower side, wherein the lower side is formed to rest on a surface; a lifting actuator attached to the base; and a chair attached to the lifting actuator, wherein the lifting actuator is operable to lift the chair to an extended position and retract the chair to a retracted position.

These and other features, aspects and advantages of the present invention will become better understood with reference to the following drawings, description and claims.

### BRIEF DESCRIPTION OF THE DRAWINGS

FIG. 1 is a perspective view of the present invention shown in extended position;

FIG. 2 is a perspective view of the present invention shown without the bellow;

FIG. 3 is a section view of the present invention along line 3-3 in FIG. 1;

FIG. 4 is a perspective view of the present invention shown in a lowered position;

FIG. 5 is a section view of the present invention along line 5-5 in FIG. 4;

FIG. 6 is a front perspective view of an alternate embodiment of the present invention shown in an extended position;

FIG. 7 is a front perspective view of an alternate embodiment of the present invention shown in a lowered position; and

FIG. 8 is a front perspective view of an alternate embodiment of the present invention shown with the seat in a pivoted position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

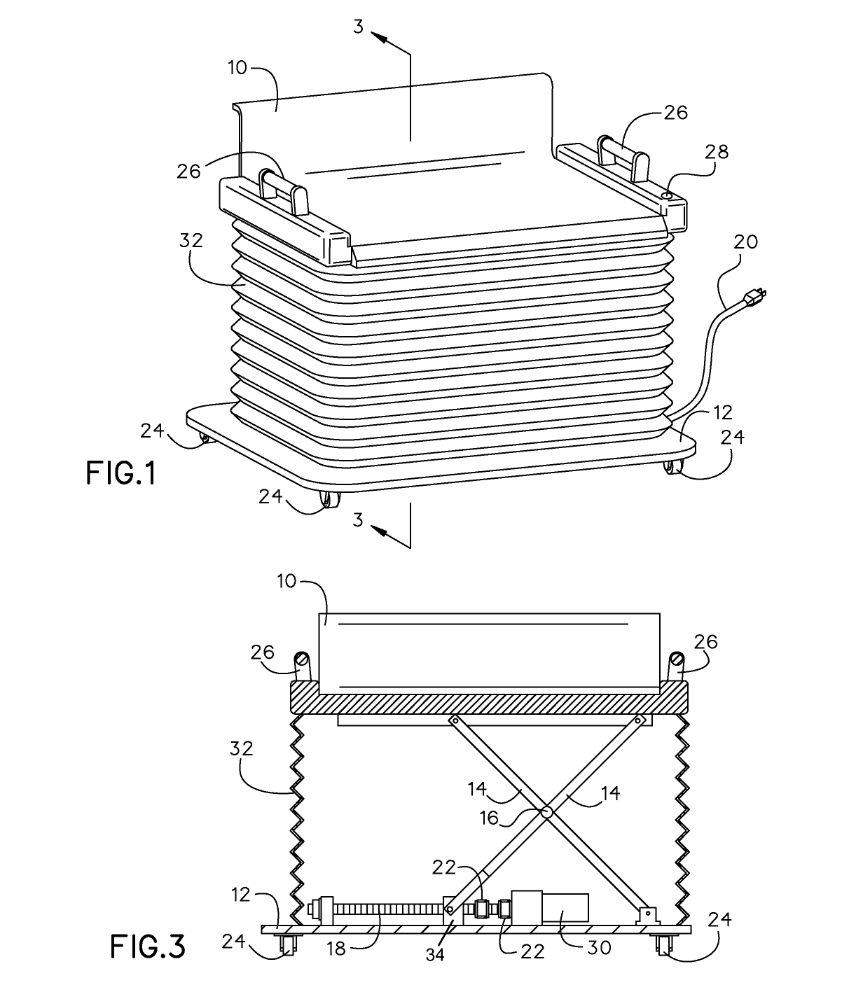

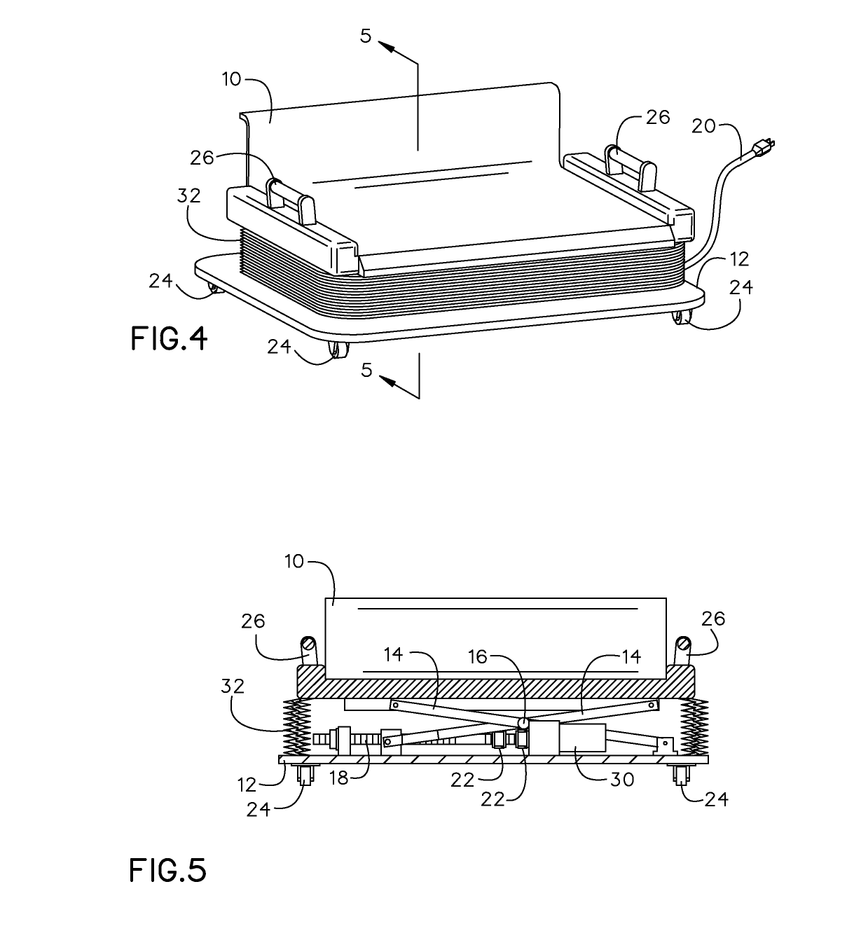

Referring to FIG. 1 through 8, the present invention includes a lifting chair. The lifting chair includes a base 12 having an upper side and a lower side. The lower side is formed to rest on a surface, supporting the lifting chair in an upright position. The present invention further includes a lifting actuator attached to the base 12 and a chair 10 attached to the lifting actuator. The lifting actuator is operable to lift the chair 10 to an extended position and retract the chair 10 to a retracted position. The extended position includes a greater distance from the base 12 to the chair 10 as compared to the retracted position. Further, the retracted position includes the chair 10 being substantially adjacent to the surface the lower side is resting on, such as a floor. Therefore, a disabled user may lower themselves and raise themselves from the floor.

The present invention may include multiple components in order to help transport the lifting chair. For example, the present invention may include a plurality of casters 24 attached to the lower side of the base 12. Therefore, a user may easily roll the lifting chair into place. Further, side wheels 52 may be attached to the side of the base 12 to easily transport the lifting chair on its side. Further, a base handle 54 may be attached the base 12 so that the user may easily grasp and position the lifting chair.

The chair 10 of the present invention may include a base portion and a back portion. The base portion may be attached to the base 12 and the back portion may support the user's back. In certain embodiments, to further retract the lifting chair, the back portion may be pivotally connected to the base portion by a chair hinge 48. Therefore, the back portion may be folded downward when the lifting chair is not in use. In certain embodiments, the chair 10 may include handles 26 on either side. The handles 26 may include a power switch 28 to easily and accessibly activate the lifting actuator.

As mentioned above, the lifting actuator of the present invention is used to raise and lower the chair 10 relative to the base 12. In certain embodiments, the lifting actuator may include a pair of pivoting arms 14 mounting the chair 10 to the upper side of the base 12. The pivoting arms are connected together by a hinge pin 16. The lifting actuator may further include at least one threaded rod 18 rotatably mounted to the base 12. The pivoting arms 14 may connect to the threaded rod 18 by a threaded receiver 34. A motor 30 may rotate the rod 18, pivoting the pair of pivoting arms 14. The pivoting of the arms 14 raises and lowers the chair 10. The motor 30 may be powered by a battery or may connect to a power outlet via a power cord 20.

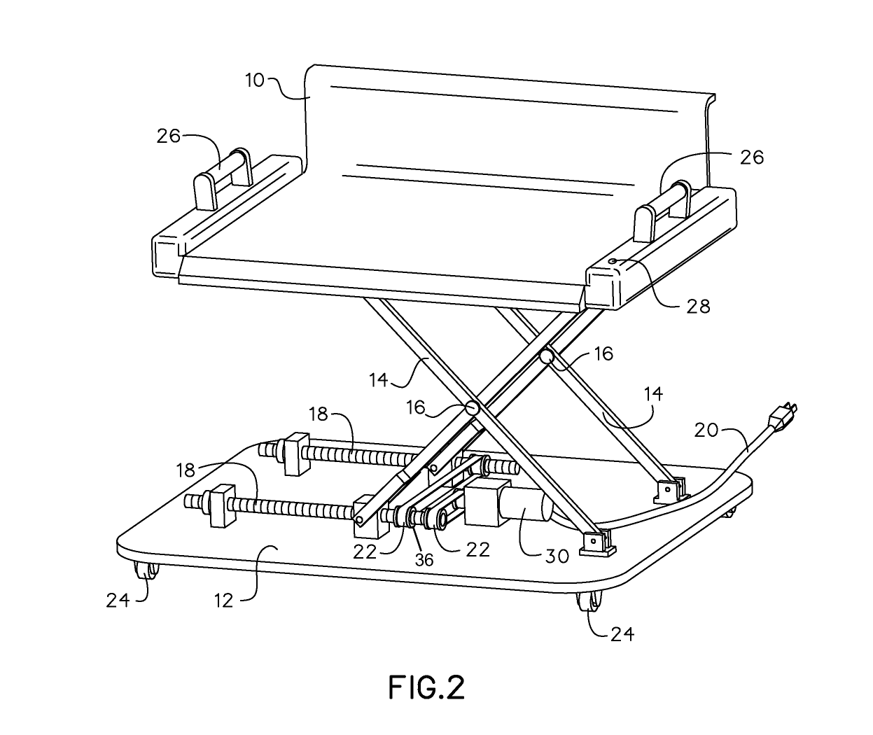

The lifting actuator of the present invention may include different configurations. As illustrated in FIGS. 2, 3 and 5, the present invention may utilize a plurality of rollers 36 and belts 22. The lifting actuator may utilize a first and second threaded rod 18. In such embodiments, the motor 30 may rotate a roller 36. The roller 36 may be connected to a roller 36 attached to the first rod 18 by a belt 22, thereby turning the first rod 18. A different roller 22 may be attached to the first rod 18 and a roller 22 may be attached to the second rod 18, which are connected by another belt 22. Therefore, the rotation of the first rod 18 rotates the second rod. A first pair of pivoting arms 14 is connected to the first threaded rod 18 by a threaded receiver 34, and a second pair of pivoting arms 14 is connected to the second threaded rod 18 by a threaded receiver 34. By rotating the first and second threaded rods 18, the threaded receivers 34 move along the threaded rods 18, thereby pivoting the first and second pair of pivoting arms 14. The pivoting of the arms 14 expands and retracts the chair 10.

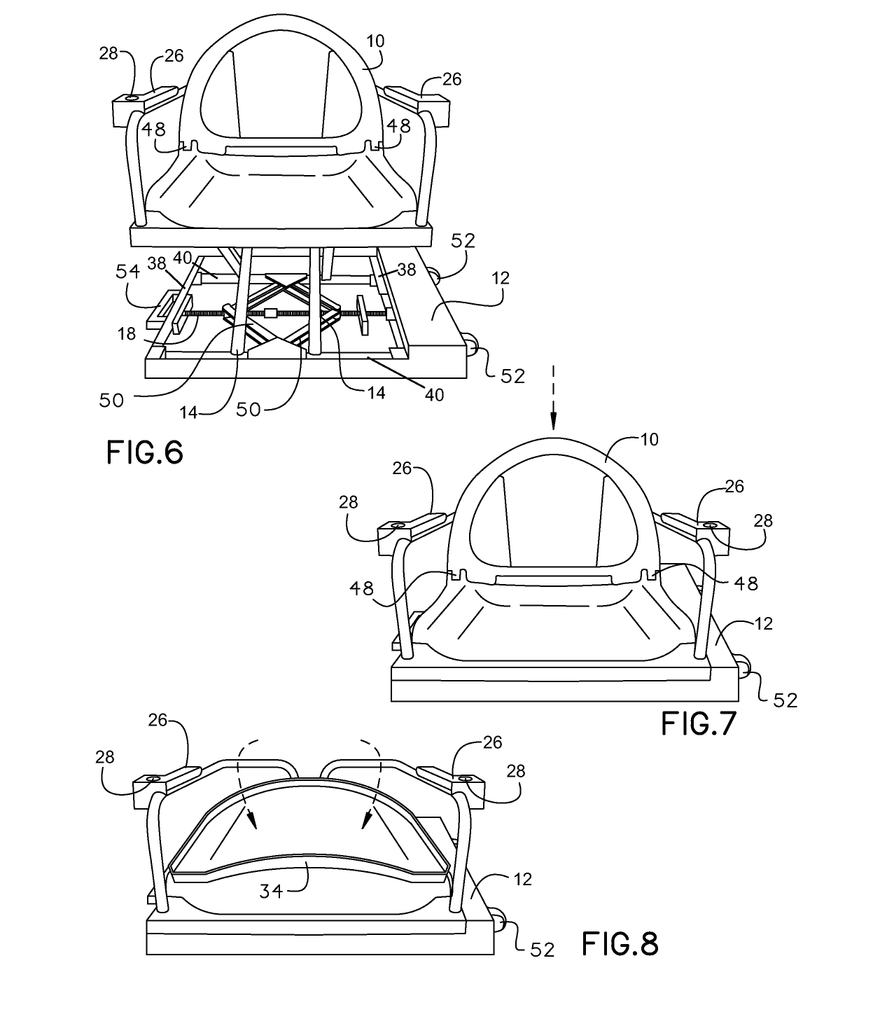

As illustrated in FIG. 6, the lifting actuator may utilize a single threaded rod 18 with a scissor jack mechanism 50. In such embodiments, the present invention may include a front support bar 40 and a rear support bar 40 within guide slots 38 of the base 12. The pair of pivoting arms 14 are attached to the front support bar 40 and the rear support bar 40. The front end of the scissor jack 50 is attached to the front support bar 40 and the rear end of the scissor jack 50 is attached to the rear support bar 40. The threaded receiver 34 may run through the center of the scissor jack 50. The threaded rod 18 is disposed within the threaded receiver 34 so that the rotation of the threaded rod 18 expands and retracts the scissor jack 50 and thereby lifts the chair 10 to the extended position and retracts the chair 10 to the retracted position.

The present invention may further include a cover to keep the lifting actuator out of site and protect the user from injury. As illustrated in FIGS. 1 and 2, the present invention may utilize a bellow 32 as the cover. The bottom of the bellow 32 may be attached to the base 10 and the top of the bellow 32 may be attached to the chair 10, thereby completely covering the lifting actuator. The below 32 may extend when the chair 10 is in the extended position and retract when the chair 10 is in the retracted position.

A method of using the present invention may include the following. At an event when an individual transfers to the lifting chair there may be handles positioned on the seat for assistance. After the individual has transferred to the lifting chair, and with a power cord providing power to the switch, the individual may turn on the three position switch from a neutral position to a lower position and the motor with the sensing circuit turned on, may begin to drive the threaded rods. During the lowering movement, bellows may be provided to prevent any accidental contact between the individual and the mechanical mechanism. In certain embodiments, a sensor may detect the floor level position and automatically cut power to the motor and the chair may stop lowering itself. At any time during this motion of lowering or lifting there may be a jamming of the lifting mechanism. In this situation the motor sensor may immediately stop the motor. With the lifting chair now at floor level, the individual may simply maneuver themselves off the chair to the floor. At a point where the individual has completed their exercise routine on the floor, they may simply maneuver themselves back onto the lifting chair, and turns the three way switch to the up position. The chair may rise until it reaches the full up position, at which time the motor sensor may sense a completely extended position and cut power to the motor.

It should be understood, of course, that the foregoing relates to exemplary embodiments of the invention and that modifications may be made without departing from the spirit and scope of the invention as set forth in the following claims.

What is claimed is:

1. A lifting chair comprising:
a base having an upper side and a lower side, wherein the lower side is formed to rest on a surface;
a lifting actuator attached to the base; and
a chair attached to the lifting actuator,
wherein the lifting actuator is operable to lift the chair to an extended position and retract the chair to a retracted position.

2. The lifting chair of claim 1, wherein the extended position comprises a greater distance from the base to the chair as compared to the retracted position.

3. The lifting chair of claim 1, further comprising a plurality of casters mounted to the base.

4. The lifting chair of claim 1, further comprising a pair of chair handles attached to the chair.

5. The lifting chair of claim 1, further comprising at least one base handle attached to the base.

6. The lifting chair of claim 1, wherein the chair comprises a base portion and a back portion, wherein the back portion is pivotally connected to the base portion.

7. The lifting chair of claim 1, further comprising a power switch electrically connected to the lifting actuator.

8. The lifting chair of claim 1, wherein the lifting actuator comprises:
a pair of pivoting arms mounting the chair to the upper side of the base;
at least one threaded rod mounted to the base and connected to the pair of pivoting arms; and
a motor operable to rotate the threaded arms, and thereby pivoting the pair of pivoting arms.

9. The lifting chair of claim 8, wherein the lifting actuator further comprises:
a front support bar and a rear support bar within guide slots of the base, wherein the pair pivoting arms are attached to the front support bar and the rear support bar; and
a scissor jack comprising a first end attached to the front support bar and a second end attached to the second support bar, and a threaded receiver,
wherein the threaded rod is disposed within the threaded receiver so that the rotation of the threaded rod expands and retracts the scissor jack and thereby lifts the chair to the extended position and retracts the chair to the retracted position.

10. The lifting chair of claim 8, wherein the at least one threaded rod is a first threaded rod and a second threaded rod and wherein lifting actuator further comprises:
a plurality of rollers mounted to the first threaded rod and the second threaded rod; and
a plurality of belts surrounding the rollers,
wherein the pair of pivoting arms are mounted to the first threaded rod and the second threaded rod by a threaded receiver,
wherein the motor is operable to turn the rollers via the plurality of belts, thereby rotating the first threaded rod and the second threaded rod, wherein the rotation of the threaded rods expands and retracts the pair of pivoting arms and thereby lifts the chair to the extended position and retracts the chair to the retracted position.
